(19) United States
(12) Patent Application Publication
(10) Pub. No.: US 2026/0219804 A1
(43) Pub. Date: Jul. 30, 2026

(54) CONTROL METHOD AND CONTROLLER FOR MEMORY, AND CHIP SYSTEM

(71) Applicant: MOORE THREADS TECHNOLOGY CO., LTD., Beijing (CN)

(72) Inventors: Rui CHEN, Beijing (CN); Fengxiang MA, Beijing (CN); Yubo ZHANG, Beijing (CN)

(73) Assignee: MOORE THREADS TECHNOLOGY CO., LTD., Beijing (CN)

(21) Appl. No.: 19/143,574

(22) PCT Filed: Dec. 22, 2023
(86) PCT No.: PCT/CN2023/141001

§ 371 Date: Jun. 26, 2025

(30) Foreign Application Priority Data
Dec. 30, 2022 (CN) 202211713991.9

(51) Int. Cl. G06F 3/06

(52) U.S. Cl. CPC G06F 3/0656; G06F 3/0625; G06F 3/0673

(57) ABSTRACT

A control method and controller for a memory, and a chip system are provided. The controller includes: time slot control determination logic, which is configured to acquire time slot configuration information for defining a time slot control mode, the time slot control mode indicating a switching mode of a working mode and sleep mode in each control period of a target memory; a command buffer, which is configured to have an access request for the target memory in the sleep mode of the target memory; and low-power consumption control logic, which is configured to control the target memory according to the time slot control mode, so that the target memory enters a low-power consumption state in the sleep mode, and processes the access request in the working mode.

### CROSS-REFERENCE TO RELATED APPLICATIONS

The present application is based on and claims priority to Chinese Patent Application No. 202211713991.9 filed on Dec. 30, 2022 and entitled “CONTROL METHOD AND CONTROLLER FOR MEMORY, AND CHIP SYSTEM”, the entire content of which is hereby incorporated by reference in its entirety.

### TECHNICAL FIELD

The present disclosure relates to the field of computer technology, and relates in particular to a control method and controller for a memory, and a chip system.

### BACKGROUND

With the development of computer technology, various high-performance computers have been widely used. For processors of various high-performance computers (e.g., Central Processing Units (CPU), Graphics Processing Units (GPU), Tensor Processing Units (TPU), Neural network Processing Units (NPU), etc.), in order to improve computing performance, it is necessary to increase a bandwidth of a memory (e.g., a Double Data Rate (DDR) memory) to match the computing performance. Typically, each DDR channel uses a separate physical layer interface unit and a DDR memory chip, and power consumption caused by the DDR accounts for a large part of the power consumption of a chip. When a processor is in a non-extreme computational scenario, a bandwidth requirement for the memory may be less than 50% of the maximum bandwidth. For example, when only a desktop is displayed, the bandwidth requirement for the memory is even lower, which may be possibly less than 10%. However, each channel still consumes significant power, which not only affects the lifetime of related devices or memory chips, but also causes a waste of resources.

### SUMMARY

In view of this, the present disclosure provides a control method and controller for a memory, and a chip system, which can reduce the power consumption of the memory and save resources.

According to a first aspect of the present disclosure, a controller for a memory is provided, which includes a slot control determination logic, a command buffer, and a low-power control logic. The slot control determination logic is configured to acquire slot configuration information for defining a slot control mode. The slot control mode indicates a switching mode between a working mode and a power-down mode in each control cycle of a target memory. The command buffer is configured to cache access requests to the target memory in the power-down mode of the target memory. The low-power control logic is configured to control the target memory according to the slot control mode, so that the target memory enters a low-power state in the power-down mode and processes the access requests in the working mode.

In some embodiments, the slot configuration information includes at least one of a number of power-down slots, a number of working slots, or a slot unit.

In some embodiments, the slot control mode includes one of: a first control mode, a second control mode or a third control mode. In the first control mode, each of a number of power-down slots, a number of working slots, and a slot unit is set to a respective fixed value. In the second control mode, each of the number of the power-down slots and the slot unit is set to a respective fixed value, and the number of the working slots is configured to be adaptive and dependent on a number of the access requests to the target memory that are cached by the command buffer in a control cycle. In the third control mode, the slot unit is configured as a fixed value, and the command buffer has a first watermark, a first watermark timeout, a second watermark and a second watermark timeout, wherein the target memory is in the power-down mode when the number of the access requests in the command buffer is less than the first watermark and a duration exceeds the first watermark timeout, and the target memory is in the working mode when the number of the access requests in the command buffer is greater than the second watermark and the duration exceeds the second watermark timeout, wherein the first watermark is less than the second watermark.

In some embodiments, the slot control determination logic is configured to: in response to the number of the access requests in a unit time period being greater than a first threshold, a degree of variation between numbers of the access requests in neighboring unit time periods being less than a second threshold, and a bandwidth required for the access requests being smaller than a total bandwidth of the target memory, acquire slot configuration information for defining the first control mode.

In some embodiments, the slot control determination logic is configured to: in response to the number of the access requests in a unit time period being less than or equal to a first threshold, or a degree of variation between numbers of the access requests in neighboring unit time periods being greater than or equal to a second threshold, and a depth of the command buffer being greater than a third threshold, acquire slot configuration information for defining the second control mode.

In some embodiments, the slot control determination logic is configured to: in response to a degree of variation between numbers of the access requests in neighboring unit time periods being greater than or equal to a second threshold and a depth of the command buffer being less than or equal to a third threshold, acquire slot configuration information for defining the third control mode.

In some embodiments, the number of the power-down slots, the number of the working slots, and the slot unit of the first control mode are configured to satisfy following conditions: a product of the number of the power-down slots, the slot unit, a total bandwidth of the target memory, and a required bandwidth utilization rate is less than or equal to a product of a depth of the command buffer and a data length of each request; a quotient obtained by dividing the number of the working slots by a sum of the number of the working slots and the number of the power-down slots is greater than or equal to the required bandwidth utilization rate; and the number of the working slots is greater than or equal to a first value; wherein a product of a quotient obtained by dividing the sum of the number of the working slots and the number of the power-down slots by a refresh cycle of the target memory, and a time required for refreshing all banks of the target memory is the first value.

In some embodiments, the number of the power-down slots and the slot unit of the second control mode are configured to satisfy following condition: a product of the number of the power-down slots, the slot unit, a total bandwidth of the target memory, and a required bandwidth utilization rate is less than or equal to a product of a depth of the command buffer and a data length of each request.

In some embodiments, the target memory is a memory of one channel among memories of multiple channels, and the slot control mode includes the first control mode; the slot control determination logic is further configured to acquire the working mode of the target memory. The working mode includes one of a synchronous mode and a sequential mode. The synchronous mode indicates that the target memory and memories of other channels among the multiple channels enter the working mode and the power-down mode synchronously, and the sequential mode indicates that the target memory and the memories of other channels among the multiple channels enter the working mode and the power-down mode in a specified order. The low-power control logic is further configured to control the target memory according to the slot control mode and the working mode, so that the target memory enters the low-power state in the power-down mode and processes the cached access requests to the target memory in the working mode.

In some embodiments, the slot control determination logic is further configured to control sending a refresh instruction to the target memory during a working slot to instruct the target memory to perform a refresh operation.

According to a second aspect of the present disclosure, a chip system is provided, which includes a target memory and any one of the controllers described in the embodiments according to the first aspect of the present disclosure.

According to a third aspect of the present disclosure, a control method for a memory is provided, which includes the following operations. Slot configuration information for defining a slot control mode is acquired. The slot control mode indicates a switching mode between a working mode and a power-down mode in each control cycle of a target memory. Access requests to the target memory in the power-down mode of the target memory are cached using a command buffer. The target memory is controlled according to the slot control mode, so that the target memory enters a low-power state in the power-down mode and processes the cached access requests to the target memory in the working mode.

In some embodiments, the slot control mode includes one of: a first control mode, a second control mode or a third control mode. In the first control mode, each of a number of power-down slots, a number of working slots, and a slot unit is set to a respective fixed value. In the second control mode, each of the number of the power-down slots and the slot unit is set to a respective fixed value, and the number of the working slots is configured to be adaptive and dependent on a number of the access requests to the target memory that are cached by the command buffer in a control cycle. In the third control mode, the slot unit is configured as a fixed value, and the command buffer has a first watermark, a first watermark timeout, a second watermark and a second watermark timeout, wherein the target memory is in the power-down mode when the number of the access requests in the command buffer is less than the first watermark and a duration exceeds the first watermark timeout, and the target memory is in the working mode when the number of the access requests in the command buffer is greater than the second watermark and the duration exceeds the second watermark timeout, wherein the first watermark is less than the second watermark.

In some embodiments, the target memory is a memory of one channel among memories of multiple channels, and the slot control mode includes the first control mode. The method further includes the operation that the working mode of the target memory is acquired. The working mode includes one of a synchronous mode or a sequential mode. The synchronous mode indicates that the target memory and memories of other channels among the multiple channels enter the working mode and the power-down mode synchronously, and the sequential mode indicates that the target memory and the memories of other channels among the multiple channels enter the working mode and the power-down mode in a specified order. The operation that the target memory is controlled according to the slot control mode includes controlling the target memory according to the slot control mode and the working mode, so that the target memory enters the low-power state in the power-down mode and processes the access requests in the working mode.

In the control method and controller for a memory and the chip system set forth in the present disclosure, the slot configuration information for defining the slot control mode is acquired, and the access requests to the target memory in the power-down mode of the target memory are cached using the command buffer. Then, the target memory is controlled according to the slot control mode to enter the low-power state in the power-down mode and process the access requests in the working mode, thereby achieving the control of the target memory based on slots. According to the present solution, it is possible to cause the target memory to automatically enter and exit the low-power state according to the slots, which can reduce power consumption and save resources without affecting the normal operation of the system and without causing data loss.

These and other advantages of the present disclosure will become apparent from and be expounded upon with reference to the embodiments described below.

It should be understood that the previous general description and the following detailed description are merely exemplary and illustrative, and do not limit the present disclosure.

### BRIEF DESCRIPTION OF THE DRAWINGS

Embodiments of the present disclosure will now be described in more detail with reference to the accompanying drawings, in which:

FIG. 1 illustrates a schematic principle framework diagram of accessing a memory of a DDR channel in the related art.

FIG. 2 illustrates a block diagram of a controller for a memory according to an embodiment of the present disclosure.

FIG. 3 illustrates a schematic principle framework diagram of accessing a memory according to an embodiment of the present disclosure.

FIG. 4 illustrates an example of a switching mode between a working mode and a power-down mode in each control cycle in a first control mode according to an embodiment of the present disclosure.

FIG. 5 illustrates an example of a switching mode between a working mode and a power-down mode in each control cycle in a first control mode according to another embodiment of the present disclosure.

FIG. 6 illustrates an example of a switching mode between a working mode and a power-down mode in each control cycle in a first control mode according to yet another embodiment of the present disclosure.

FIG. 7 illustrates an example of a switching mode between a working mode and a power-down mode in each control cycle in a first control mode according to still another embodiment of the present disclosure.

FIG. 8 illustrates an example of a switching mode between a working mode and a power-down mode in each control cycle in a second control mode according to an embodiment of the present disclosure.

FIG. 9 illustrates an example of a switching mode between a working mode and a power-down mode in each control cycle in a third control mode according to an embodiment of the present disclosure.

FIG. 10 illustrates a schematic diagram of memories of multiple channels synchronously entering a working mode and a power-down mode in a synchronous mode according to an embodiment of the present disclosure.

FIG. 11 illustrates a schematic diagram of memories of multiple channels sequentially entering a working mode and a power-down mode in a sequential mode according to an embodiment of the present disclosure.

FIG. 12 illustrates an exemplary flowchart of a control method for a memory according to an embodiment of the present disclosure.

### DETAILED DESCRIPTION

The following description provides specific details of various embodiments of the present disclosure to enable those skilled in the art to fully understand and implement various embodiments of the present disclosure. It should be understood that the technical solutions of the present disclosure may be implemented without some of these details. In some cases, some well-known structures or functions are shown or described in detail in the present disclosure, to avoid unnecessarily obscuring the description of the embodiments of the present disclosure. The terms used in the present disclosure should be construed in their broadest reasonable manner, even though they are used in conjunction with specific embodiments of the present disclosure.

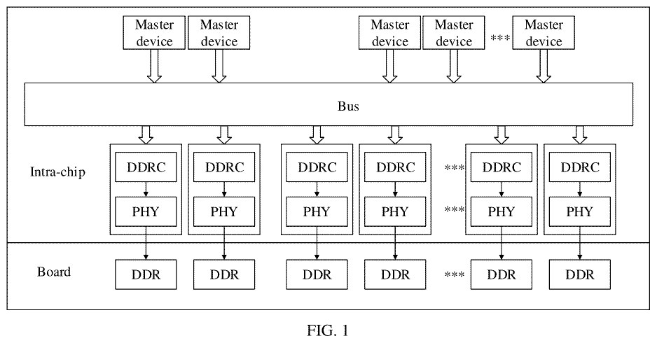

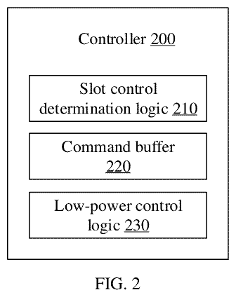

FIG. 1 shows a schematic principle framework diagram of accessing a memory of a DDR channel in the related art. As shown in FIG. 2, multiple master devices (e.g., a CPU or a GPU of a chip, etc.) access multiple channels of DDR via a bus, here, for example, 8 channels of DDR. DDRC refers to a controller for the DDR, and functions to convert a read/write request or the like into a command for the DDR to generate signal timing. PHY refers to a DDR physical layer interface unit, and functions to process timing, which is a channel that allows DDR address commands and data to be transmitted correctly according to a protocol. DDR refers to a DDR memory chip or device, such as an on-board or off-chip memory chip. When the multiple master devices access a segment of consecutive physical addresses, the eight DDR channels work in parallel to provide a maximum bandwidth.

DDR would be used below as an example to describe that there are generally several methods for achieving the low power consumption.

Solution 1: Reducing the working frequency of the memory. This solution can dynamically change the frequency according to an actual application scenario, and dynamically reduce the power consumption. Even if the DDR channel is working at the lowest frequency, it (e.g., the PHY and DDR memory chips described above, etc.) is in a working mode, and there is significant power consumption.

Solution 2: Causing the memory to enter a low-power mode. This solution allows all DDR channels, including the PHY and DDR memory chips described above, to enter the low-power mode only when the DDR has no bandwidth requirements at all (e.g., computer sleep, power-down, and other modes). At this time, the power consumption of the DDR is low, but no DDR channel can receive a command. If a command needs to be received, it takes a long time to exit said mode. Therefore, this solution cannot be applied to a scenario in which the demand for bandwidth is small but the demand occurs continuously.

Solution 3: Turning off the clock of the memory. This solution is similar to the solution 2, and the power consumption of the PHY and DDR memory chips is further reduced by turning off the clock of the DDR after the DDR enters the low-power mode. The disadvantage is that it is also unable to be used in a scenario in which the demand for bandwidth is small but the demand occurs continuously.

Solution 4: Turning off the power supply of the memory. This solution is to completely turn off the power supply of the PHY and DDR memory chips, so as to be in a completely power-free mode. However, in this mode, data cached in the DDR will be lost, and similarly to schemes 2 and 3, all DDR channels are powered off and unable to receive a command. The solution is generally used only in the case of power-down or shutdown.

Solution 5: Dynamically switching DDR channels. In this way, at least one channel needs to be reserved, power consumption of one channel still needs to be ensured in the case of very small traffic, and at the same time, the dynamic switching needs to perform data migration and address remapping.

On this basis, the embodiments of the present disclosure provide a control method and controller for a memory based on slots, thereby reducing the power consumption of the memory (DDR).

FIG. 2 illustrates a block diagram of a controller 200 for a memory according to an embodiment of the present disclosure. The controller 200 may be used, for example, as a controller for a DDR memory (i.e., a DDRC). As shown in FIG. 2, the controller 200 includes a slot control determination logic 210, a command buffer 220, and a low-power control logic 230.

The slot control determination logic 210 is configured to acquire slot configuration information for defining a slot control mode. The slot control mode is configured to indicate a switching mode between a working mode and a power-down mode in each control cycle of a target memory. The target memory here may be, for example, a DDR memory. As an example, the slot configuration information may be stored in various suitable storage apparatuses in advance or configured in real time as needed, which would not be limiting. The slot configuration information may include at least one of a number of power-down slots (pd_slot_num), a number of working slots (wk_slot_num), or a slot unit (slot_unit).

The number of the power-down slots represents the number of the power-down slots, and the product of the slot unit (slot_unit) and the number of the power-down slots (pd_slot_num) represents a duration of a single the power-down mode cycle. In the case of using a DDR memory, the maximum power-down duration (duration of the power-down mode) needs to be less than 9 tREFIs (refresh cycle of the memory), which is determined by the characteristics of the DDR. The wk_slot_num represents the number of the working slots, and the product of the slot unit (slot_unit) and the number of the working slots (wk_slot_num) represents a duration of a single working mode cycle, i.e., a working duration.

Each control cycle includes one power-down mode and one working mode. In the working mode, a refresh operation is performed on the target memory, and access requests to the target memory are processed. The switching mode between the working mode and the power-down mode in each control cycle of the target memory may define entry and exit conditions of the working mode and the power-down mode. In some embodiments, the slot control determination logic 210 is further configured to send a refresh instruction to the target memory during the working slot, and the refresh instruction is used for instructing the target memory to perform the refresh operation.

In some embodiments, the slot control mode includes one of a first control mode, a second control mode, or a third control mode. In the first control mode, each of the number of the power-down slots. The number of the working slots, and the slot unit is set to a respective fixed value, and the power-down duration and the working duration in each control cycle may be determined by means of the number of the power-down slots, the number of the working slots, and the slot unit. In the second control mode, each of the number of the power-down slots and the slot unit is set to a respective fixed value, and the working duration may thus be determined. The number of the working slots is configured to be adaptive and control the number of the access requests to the target memory that are cached by the command buffer in the cycle. In other words, in the second control mode, when no command is cached in the command buffer, the working duration is only used to complete the necessary refresh operation, and the target memory may enter the power-down mode immediately after the necessary refresh operation is completed. When the command buffer has a command cached therein, the target memory may, in the working mode, process the commands cached in the buffer until the command buffer is empty. In the third control mode, the slot unit is set to a fixed value, and the command buffer is configured with a first watermark, a first watermark timeout, a second watermark and a second watermark timeout. In the third control mode, the target memory is in the power-down mode when the number of the access requests in the command buffer is less than the first watermark and a duration exceeds the first watermark timeout. In the third control mode, the target memory is in the working mode when the number of access requests in the command buffer is greater than the second watermark and the duration exceeds the second watermark timeout. The first watermark is less than the second watermark.

The command buffer 220 is configured to cache access requests (e.g., by a master device) to the target memory in the power-down mode of the target memory. When the target memory is in the power-down mode, and the access requests to the target memory are received, for example, from the master device, since the target memory cannot process the access requests, the requests may be cached in the command buffer 220, until the target memory processes the access requests in the working mode. The access request to the target memory may be, for example, a read request to the target memory, a write request to the target memory, or the like. Here, the read request is a request for reading data from the target memory, and the write request is a request for writing data to the target memory. Typically, a larger buffer depth may support longer power-down duration, but may consume more hardware resources while increasing the latency of read/write operations. When the buffer depth is determined, the power-down duration is determined according to the bandwidth of the memory required by the master device, so that the possibility that the buffer is in a full state for a long time can be reduced, and the system performance can be improved.

The low-power control logic 230 is configured to control the target memory according to the slot control mode, so that the target memory can enter the low-power state in the power-down mode and process the cached access requests to the target memory in the working mode. By causing the target memory to enter the low-power state in the power-down mode and process the cached access requests in the working mode, the power consumption of the memory can be minimized. In the case of using the DDR memory, the low-power state herein may refer to a state in a power-down mode of a DDR memory chip. All DDR memory chips (DDR3/4/5, LPDDR3/4/5, and GDDR5/6) have a power-down mode in which significant power consumption can be reduced. Compared with self-refresh and deep power-down modes, the entry time and exit time of the power-down mode are shorter, which is more suitable for dynamic and automatic low-power control.

In the power-down mode, typically, the maximum power-down duration is 9 times tREFI, and tREFI represents a refresh cycle of the target memory. Taking the GDDR6 as an example, tREFI is typically 1.9 μs, and the maximum power-down duration is 17.1 μs. The time duration of being in the power-down mode is about 5 ns, and the time duration of not being in the power-down mode is about 5 ns, both of which are relatively short.

Because the memory (e.g., a DDR memory chip) does not perform an internal refresh operation in the power-down mode, the required refresh operation may be sent by the controller (e.g., a DDR controller) after exiting the power-down mode. In the case of using a Refresh All Bank (REFab) mode, the controller may send nine refresh instructions, and the time required is nine times tRFCab, tRFCab representing the time required for each bank refresh of the target memory in the refresh mode. In the REFab mode, all banks are simultaneously refreshed at once. Taking the GDDR6 as an example, tRFCab is 120 ns, and the time required for refresh is about 1.08 μs. The read/write request cannot be processed during the execution of REFab. Moreover, taking the GDDR6 as an example, a 6.3% of bandwidth loss is required for REFab. In the case of using a Refresh per bank (REFpb) mode, the time required to send a refresh instruction is nine times the product of number_bank and tRFCpb. The number_bank is the number of all banks, and tRFCpb is the time required to refresh each bank of the target memory in the refresh mode, which is about 60 ns. In the REFpb mode, each bank is refreshed individually. For example, when the total number of banks is 16, 9×16×60 ns=8.6 μs is required. The read/write request may be processed concurrently during the execution of the REFpb, and in the REFpb mode, the working duration needs to be more than 50.5% of the total duration.

In the controller 200 for a memory provided by the embodiments of the present disclosure, the slot configuration information for defining the slot control mode is acquired by the slot control determination logic 210, and the access requests to the target memory in the power-down mode of the target memory are cached by the command buffer 220. Then, the low-power control logic 230 controls, according to the slot control mode, the target memory to enter the low-power state in the power-down mode and process the access requests in the working mode, thereby achieving the control of the target memory based on slots. The present solution can cause the target memory to automatically enter or exit the low-power state according to the slots, which does not lead to the problems such as data loss while reducing the power consumption, and does not affect the normal operation of the system.

According to the embodiments of the present disclosure, a chip system including a target memory and a controller for the target memory is further provided. The controller may be, for example, the controller 200 described with reference to FIG. 2. The chip system may be implemented in the form of a common chip.

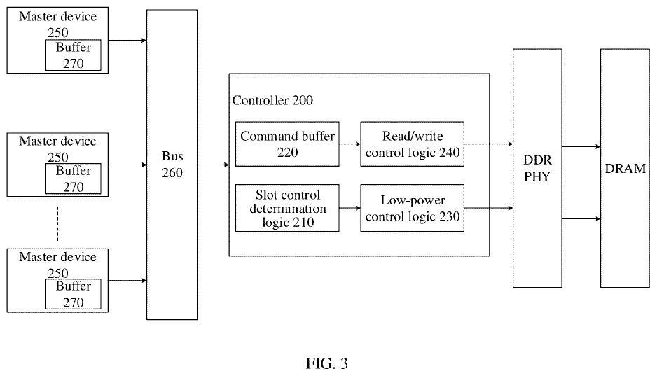

FIG. 3 illustrates a schematic principle framework diagram of accessing a memory according to an embodiment of the present disclosure. The target memory being a DDR memory (DRAM) is used as an example. As shown in FIG. 3, multiple master devices 250 are connected to a memory controller 200 (a DDR controller, i.e., DDRC) through a bus 260 to perform a read/write operation of the DDR memory. The DDR controller includes a command buffer 220 configured to cache the access requests to the DDR memory in a power-down mode of the DDR memory. In some embodiments, a buffer 270 may also be included in each master device 250, and is configured to cache a burst command request and mitigate the DDR latency. In FIG. 3, the chip system may include the controller 200 and the DDR memory. In some embodiments, the chip system may further include a DDR PHY.

The DDR controller further includes a slot control determination logic 210 and a low-power control logic 230. As described with reference to FIG. 2, the slot control determination logic 210 is configured to acquire slot configuration information for defining a slot control mode. The slot control mode is configured to indicate a switching mode between a working mode and a power-down mode in each control cycle of the target memory. The low-power control logic 230 is configured to control the DDR memory according to the slot control mode, so that the DDR memory enters the low-power state (together with the DDR PHY) in the power-down mode and processes the cached access requests to the DDR memory in the working mode. In some embodiments, the DDRC may further include a read/write control logic 240 configured to send (e.g., which may be via the DDR PHY) a read/write request or command to the DDR memory in the working mode.

Typically, the product of the bandwidth of the DDR required by the master device and the power-down duration needs to be equal to the depth of the buffer. Thus, a larger buffer depth may support longer power-down duration. When the buffer depth is determined, the power-down duration may be determined according to the bandwidth of the memory required by the master device, so as to minimize the impact on the system performance due to that the buffer is in a full state for a long time.

In an embodiment of the present application, the slot control mode includes one of a first control mode, a second control mode, or a third control mode.

In the first control mode, each of the number of power-down slots, the number of working slots, and a slot unit is set to a respective fixed value. In some embodiments, the number of the power-down slots, the number of the working slots, and the slot unit in the first control mode are configured to satisfy the following conditions: (1) the product of the number of the power-down slots, the slot unit, the total bandwidth of the target memory, and a required bandwidth utilization rate is less than or equal to the product of the depth of the command buffer and the data length of each request; (2) a quotient obtained by dividing the number of the working slots by the sum of the number of the working slots and the number of the power-down slots is greater than or equal to the required bandwidth utilization rate; and (3) the number of the working slots is greater than or equal to a first value N1. Reference can be made to Formula (1).

$$N 1 = \frac{S}{tREFI} \times tRFC \qquad Formula ( 1 )$$

S is a sum of the number of the working slots and the number of the power-down slots, tREFI represents a refresh cycle of the target memory, and tRFC represents the time required for refreshing all banks of the target memory. Of course, as described above, some mandatory regulations need to be satisfied as well. For example, the maximum power-down duration needs to be less than nine tREFIs (taking GDDR6 (tREFI=1.9 μs) as an example, the maximum power-down duration is 17.1 μs), which is determined by the characteristics of the DDR, and the number of the working slots and the number of the power-down slots need to be positive integers.

As an example, assuming that the depth of the command buffer in a chip system is 512, the data length of each request or command is 128 Bytes, the total bandwidth of the DDR memory is 32 GByte/s, and tREFI=1.9 μs. When the Refresh All Bank (REFab) mode is used, tRFC=tRFCab=120 ns, and when the Refresh per bank (REFpb) mode is used, tRFC=16×tRFCpb=0.96 μs (typically, there are 16 banks).

When the bandwidth utilization rate required by the master device is 50%, it can be obtained according to condition (1) that the power-down duration needs to be less than or equal to 512×128/(32×50%)=4096 ns=4.096 μs, which is less than the maximum power-down duration of 17.1 μs, thereby meeting the requirement. The power-down duration is the product of the number of the power-down slots and the slot unit. According to condition (2), the quotient obtained by dividing the number of the working slots by the sum of the number of the working slots and the number of the power-down slots needs to be greater than or equal to the required bandwidth utilization rate. According to condition (3), the number of the working slots is greater than or equal to the first value N1, that is, the quotient obtained by dividing the number of the working slots by the sum of the number of the working slots and the number of the power-down slots needs to be greater than or equal to tRFC/tREFI.

As described above, there are two refresh modes, i.e., the Refresh All Bank (REFab) mode and the Refresh per bank (REFpb) mode. In the case of using the Refresh All Bank (REFab) mode, the quotient needs to be greater than or equal to 50% according to condition (2), and it needs to be greater than 6.3% (tRFC/tREFI=120 ns/1.9 μs=6.3%) according to condition (3). As described previously, 6.3% of the bandwidth loss is required for REFab in this mode, and 6.3% of the bandwidth in this mode is not an effective bandwidth. Therefore, the quotient is preferably greater than 50%+6.3%. In this case, it may be selected such that the number of the working slots is seven, the number of the power-down slots is five, and the slot unit is 4.096 μs/5=0.8192 μs.

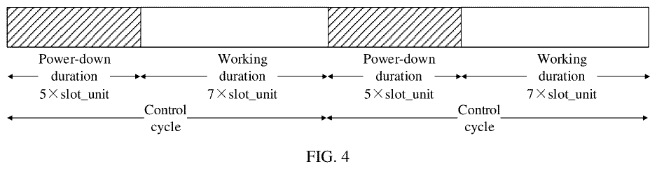

Exemplarily, FIG. 4 illustrates an example of a switching mode between the working mode and the power-down mode in each control cycle in the Refresh All Bank mode. The number of working slots is seven, the number of power-down slots is five, and the slot unit (slot_unit) is 4.096 μs/5-0.8192 μs.

In the case of using the Refresh per bank (REFpb) mode, the quotient needs to be greater than or equal to 50% according to condition (2), and greater than 50.5% (tRFC/tREFI=0.96 μs/1.9 μs=50.5%) according to condition (3). In the REFpb mode, the working duration needs to be greater than 50.5% of the total duration. In this case, it may be selected such that the number of the working slots is 16, the number of the power-down slots is 15, and the slot unit is 4.096 μs/15=0.8192 μs.

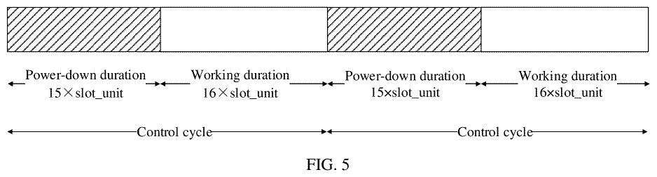

Exemplarily, FIG. 5 illustrates an example of a switching mode between the working mode and the power-down mode in each control cycle in the Refresh per bank mode. The number of working slots is 16, the number of power-down slots is 15, and the slot unit is 4.096 μs/5=0.273 μs.

As another example, assuming that the depth of the command buffer in a chip system is 512, the data length of each request or command is 128Bytes, and the total bandwidth of the DDR memory is 32GByte/s. When the bandwidth utilization rate required by the master device is 10%, it can be obtained according to condition (1) that the power-down duration (the number of the power-down slots×the slot unit) needs to be less than or equal to 512×128/(32×10%)=20.48 μs, which is greater than the maximum power-down duration of 17.1 μs. Therefore, the power-down duration may be determined as 17 μs.

According to condition (2), the quotient obtained by dividing the number of the working slots by the sum of the number of the working slots and the number of the power-down slots needs to be greater than or equal to the required bandwidth utilization rate. According to condition (3), the number of the working slots is greater than or equal to the first value. It can be obtained that the quotient obtained by dividing the number of the working slots by the sum of the number of the working slots and the number of the power-down slots needs to be greater than or equal to tRFC/tREFI.

As described above, there are two refresh modes, i.e., the Refresh All Bank (REFab) mode and the Refresh per bank (REFpb) mode.

In the case of using the Refresh All Bank (REFab) mode, the quotient needs to be greater than or equal to 10% according to condition (2), and needs to be greater than 6.3% according to condition (3). As described previously, 6.3% of the bandwidth loss is required for REFab in this mode, and 6.3% of the bandwidth in this mode is not an effective bandwidth. Therefore, the quotient is preferably greater than 10%+6.3%. In this case, it may be selected such that the number of the working slots is two, the number of the power-down slots is 10, and the slot unit is 17 μs/10=1.7 μs.

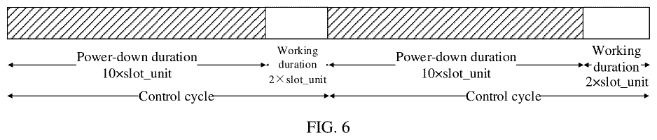

Exemplarily, FIG. 6 illustrates an example of a switching mode between the working mode and the power-down mode in each control cycle in this refresh mode. The number of the working slots is two, the number of the power-down slots is 10, and the slot unit is 17 μs/10=1.7 μs.

In the case of using the Refresh per bank (REFpb) mode, the quotient needs to be greater than or equal to 10% according to condition (2), and needs to be greater than 50.5% according to condition (3) (in the REFpb mode, the working duration needs to be greater than 50.5% of the total duration). In this case, the quotient is still required to be greater than 50.5%. It may be selected such that the number of the working slots is six, the number of the power-down slots is five, and the slot unit is 17 μs/5=3.4 μs.

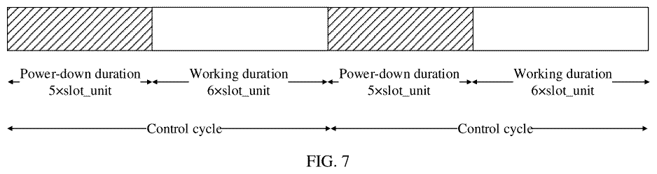

Exemplarily, FIG. 7 illustrates an example of a switching mode between the working mode and the power-down mode in each control cycle in this refresh mode. The number of the working slots is 6, the number of the power-down slots is 5, and the slot unit is 17 μs/5-3.4 μs.

In some embodiments, the slot control determination logic is configured to, in response to the number of the access requests in a unit time period being larger than a first threshold, a degree of variation between numbers of the access requests in neighboring unit time periods being smaller than a second threshold, and a bandwidth required for the access requests being smaller than the total bandwidth of the target memory, acquire slot configuration information for defining the first control mode.

In an embodiment of the present disclosure, the degree of variation between numbers of the access requests in neighboring unit time periods may be the difference between the numbers of the access requests in the neighboring time periods. That is, the first control mode is used when the number of the access requests to the target memory by the master device is large, the access requests occur continuously, and the required bandwidth is smaller than the total bandwidth of the target memory. The first threshold and the second threshold here may be set as needed, and the values thereof are not limited.

In the second control mode, each of the number of power-down slots and the slot unit is set to a respective fixed value, and the number of working slots is configured to be determined according to the number of the access requests to the target memory that are cached by the command buffer in the control cycle. In some embodiments, the number of the power-down slots and the slot unit in the second control mode are configured to satisfy the following condition: the product of the number of the power-down slots, the slot unit, the total bandwidth of the target memory, and the required bandwidth utilization rate is less than or equal to the product of the depth of the command buffer and the data length of each request. In some embodiments, the maximum power-down duration needs to be less than nine tREFIs (taking GDDR6 (tREFI=1.9 μs) as an example, the maximum power-down duration is 17.1 μs), which is determined by the characteristics of the DDR, and the number of the power-down slots needs to be a positive integer.

As an example, it is assumed that the depth of the command buffer in a chip system is 512, the data length of each request or command is 128 Bytes, and the total bandwidth of the DDR memory is 32 GByte/s. When the bandwidth utilization rate required by the master device is 10%, it can be obtained according to the condition that the power-down duration (the product of the number of the power-down slots and the slot unit) needs to be less than or equal to 512×128/(32×10%)=20.48 μs. Meanwhile, it is determined by the DDR characteristics that the maximum power-down duration needs to be less than 17.1 μs, and the power-down duration may thus be determined as 17 μs. Moreover, since the number of the working slots does not need to be configured (which is adaptive), the number of power-down slots may be set to 10, and the length of the power-down slots may be controlled by setting the slot unit, that is, the number of the power-down slots is set to 10 and the slot unit is set to 1.7 μs, which would not be limited.

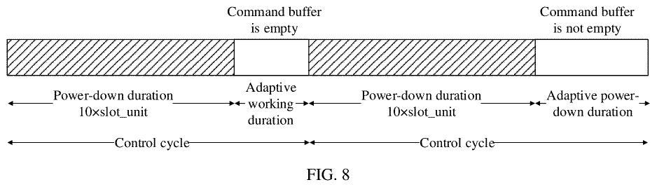

It should be noted that the Refresh per bank (REFpb) mode is not applicable to this control mode because its use requires that the working slots accounts for at least 50.5% of the total slots, and for this control mode, only the Refresh All Bank (REFab) mode can be used. FIG. 8 illustrates an example of a switching mode between the working mode and the power-down mode in each control cycle in the REFab refresh mode, in which the number of power-down slots is 10, the slot unit is 1.7 μs, and the number of working slots is adaptive (i.e., the working duration is adaptive). As shown in FIG. 8, when the first working slot is reached, the DDR memory enters the power-down slot immediately after performing the necessary refresh because there is no command in the command buffer. When the second working slot is reached, the command buffer is not empty, and the DDR memory remains in the working mode until the command buffer is empty.

In some embodiments, the slot control determination logic is configured to, in response to the number of the access requests in the unit time period being less than or equal to a first threshold, or a degree of variation between numbers of the access requests in neighboring unit time periods being greater than or equal to a second threshold, and the depth of the command buffer being less than or equal to a third threshold, acquire slot configuration information for defining the second control mode. In other words, the second control mode may be used when there are relatively few access requests to the target memory by the master device, a burst read/write request may occur, and the depth of the command buffer is large. The first threshold value, the second threshold value, and the third threshold value here may be set as needed, and the values thereof are not limited.

In the third control mode, the slot unit is set as a fixed value, and the command buffer has a first watermark, a first watermark timeout, a second watermark, and a second watermark timeout. The target memory is in the power-down mode when the number of the access requests in the command buffer is less than the first watermark and the duration exceeds the first watermark timeout, and the target memory is in the working mode when the number of the access requests in the command buffer is greater than the second watermark and the duration exceeds the second watermark timeout. The first watermark is less than the second watermark. Of course, as described above, some mandatory regulations need to be satisfied as well. For example, the maximum power-down duration needs to be less than nine tREFIs (taking GDDR6 (tREFI=1.9 μs) as an example, the maximum power-down duration is 17.1 μs), which is determined by the characteristics of the DDR.

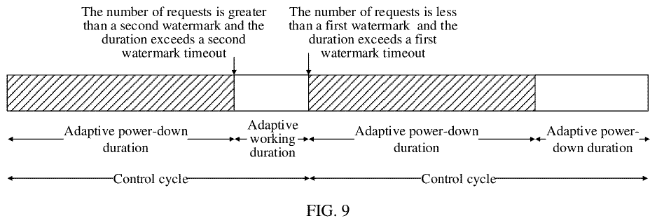

FIG. 9 illustrates an example of a switching mode between the working mode and the power-down mode in each control cycle in the third control mode. As shown in FIG. 9, the target memory is in the power-down mode when the number of the access requests in the command buffer is less than the first watermark and the duration exceeds the first watermark timeout, and the target memory is in the working mode when the number of the access requests in the command buffer is greater than the second watermark and the duration exceeds the second watermark timeout. In the third control mode, the Refresh All Bank (REFab) mode and the Refresh per bank (REFpb) mode may be used.

In some embodiments, the slot control determination logic is configured to: in response to a degree of variation between numbers of the access requests in neighboring unit time periods being greater than or equal to a second threshold and a depth of the command buffer being less than or equal to a third threshold, acquire slot configuration information for defining the third control mode. In other words, the third control mode may be used when the read/write requests are non-uniform, burst read/write requests occur occasionally, and the depth of the command buffer is small. The third threshold value here may be set as needed, and the value thereof is not limited.

In some embodiments, there are memories of multiple channels (e.g., in a chip system), and the target memory is a memory of one channel among the memories of multiple channels. In this case, when the slot control mode is the first control mode described above, the slot control determination logic is further configured to acquire the working mode of the target memory. The working mode includes one of a synchronous mode or a sequential mode. The synchronous mode is configured to indicate that the target memory and memories of other channels among the multiple channels enter the working mode and the power-down mode synchronously, and the sequential mode is configured to indicate that the target memory and the memories of other channels among the multiple channels enter the working mode and the power-down mode in a specified order. Meanwhile, the low-power control logic is further configured to collectively control the target memory according to the slot control mode and the working mode, so that the target memory enters the low-power state in the power-down mode and processes the cached access requests to the target memory in the working mode.

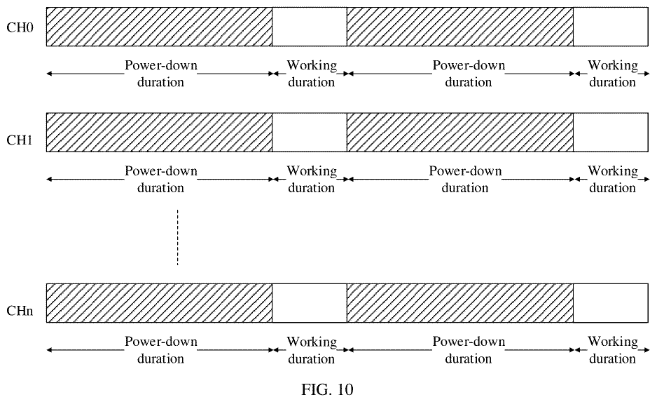

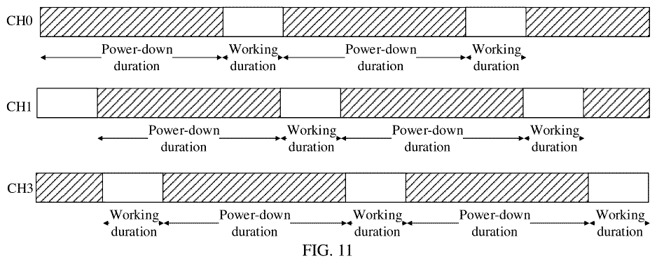

FIG. 10 illustrates a schematic diagram of memories of multiple channels synchronously entering a working mode and a power-down mode in a synchronous mode according to an embodiment of the present disclosure. FIG. 11 illustrates a schematic diagram of memories of multiple channels sequentially entering a working mode and a power-down mode in a sequential mode according to an embodiment of the present disclosure. As shown in FIG. 10, memories of (n+1) channels CH0−CHn (n being a positive integer) synchronously enter the working mode and the power-down mode, and accordingly synchronously exit the working mode and the power-down mode. In a multi-channel DDR system, the access requests from the master devices may be allocated to different channels. When each of the number of the power-down slots, the number of the working slots, and the slot unit is set to a respective fixed value, the working mode of memories of multiple channels is set to the synchronous mode, and all channels enter the working mode and the power-down mode at the same time, which can reduce the system latency and is suitable for use in a latency-sensitive scenario. As shown in FIG. 11, the working mode of memories of three channels, i.e., CH0, CH1, and CH3, is set to the sequential mode, and the three different channels enter the working mode in sequence or sequentially, which can reduce the maximum power consumption and is suitable for use in a power consumption-sensitive scenario.

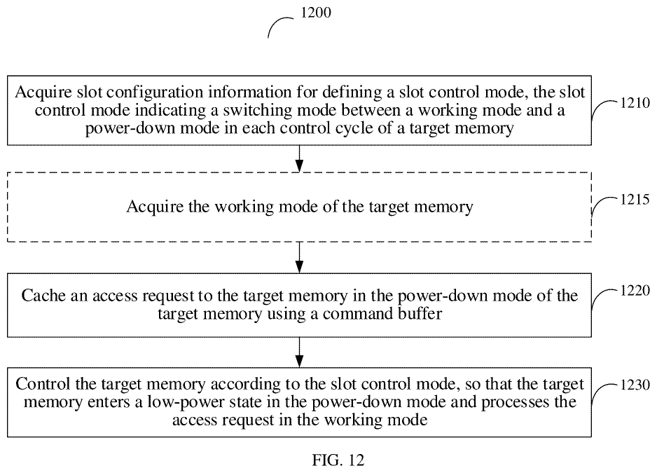

FIG. 12 illustrates an exemplary flowchart of a control method 1200 for a memory according to an embodiment of the present disclosure. The method 1200 may be implemented by the controller for a memory as described with reference to FIG. 2. As shown in FIG. 12, the method includes the following operations.

At operation 1210, slot configuration information for defining a slot control mode is acquired. The slot control mode indicates a switching mode between a working mode and a power-down mode in each control cycle of a target memory.

In an embodiment of the present application, the target memory may be, for example, a DDR memory. As an example, the slot configuration information may be stored in various suitable storage apparatuses in advance or may be configured in real time as needed, which is not limiting. The slot configuration information may include at least one of a number of the power-down slots (pd_slot_num), a number of the working slots (wk_slot_num), or a slot unit (slot_unit).

In some embodiments, the slot control mode includes one of: a first control mode, a second control mode or a third control mode. In the first control mode, each of a number of the power-down slots, a number of the working slots, and a slot unit is set to a respective fixed value, and a power-down duration and a working duration in each control cycle may be determined by means of the number of the power-down slots, the number of the working slots, and the slot unit. In the second control mode, each of the number of the power-down slots and the slot unit is set to a respective fixed value and the working duration may thus be determined. The number of the working slots is configured to be adaptive and dependent on the number of the access requests to the target memory that are cached by a command buffer in the control cycle. In other words, in the second control mode, when no command is cached in the command buffer, the working duration is only used to complete a necessary refresh operation, and the power-down mode is entered again immediately after the completion. When the command buffer has a command cached therein, the commands cached in the buffer are processed in the working mode until the command buffer is empty. In the third control mode, it is required that the slot unit is set to a fixed value, and a first watermark, a first watermark timeout, a second watermark, and a second watermark timeout configured for the command buffer are used. In the third control mode, the target memory is in the power-down mode when the number of the access requests in the command buffer is less than the first watermark and a duration exceeds the first watermark timeout, and the target memory is in the working mode when the number of the access requests in the command buffer is greater than the second watermark and the duration exceeds the second watermark timeout. The first watermark is less than the second watermark.

At operation 1220, the access requests to the target memory in the power-down mode of the target memory are cached by the command buffer. Typically, a larger buffer depth may support longer power-down duration, but may consume more hardware resources while increasing the latency of read/write operations. When the buffer depth is determined, the power-down duration is determined according to the bandwidth of the memory required by a master device, to minimize the buffer being in a full state for a long time.

At operation 1230, the target memory is controlled according to the slot control mode, so that the target memory enters a low-power state in the power-down mode and processes the access requests in the working mode.

In some embodiments, the target memory is a memory of one channel among memories of multiple channels, and the slot control mode includes a first control mode. The method may further include the operation 1215 that a working mode of the target memory is acquired. The working mode includes one of a synchronous mode or a sequential mode. The synchronous mode is configured to indicate that the target memory and memories of other channels among the multiple channels enter the working mode and the power-down mode synchronously, and the sequential mode is configured to indicate that the target memory and the memories of other channels among the multiple channels enter the working mode and the power-down mode in a specified order. The operation 1215 may be executed simultaneously with the operation 1210, or may be executed before or after the operation 1210, and the order of execution is not limited. In this case, the operation 1230 may include the operation that the target memory is controlled according to the slot control mode and the working mode, so that the target memory enters the low-power state in the power-down mode and processes the cached access requests to the target memory in the working mode.

It should be noted that the method may have the same embodiments and technical effects as those of the controller for a memory described with reference to FIGS. 2 and 3, which will not be described in detail here.

In the method for controlling a memory provided by the embodiments of the present disclosure, the slot configuration information for defining the slot control mode is acquired, and the access requests to the target memory in the power-down mode of the target memory are cached using the command buffer. Then, the target memory is controlled according to the slot control mode to enter the low-power state in the power-down mode and process the access requests in the working mode, thereby achieving the control of the target memory based on slots. The present solution can cause the target memory to automatically enter or exit the low-power state according to the slots, which does not result in the problems such as data loss while reducing the power consumption, and does not affect the normal operation of the system.

It should be understood that, for the purpose of clarity, the embodiments of the present disclosure are described with reference to different functional units or logics. However, it is apparent that the functionality of each functional unit or logic may be implemented in a single unit or logic, in multiple units or logic, or as part of other functional units or logic without departing from the present disclosure. For example, the functionality illustrated to be performed by a single unit or logic may be performed by multiple different units or logics. Therefore, references to specific functional units or logics are only regarded as references to suitable units or logics for providing the described functionality rather than indicative of a strict logical or physical structure or organization.

It can be understood that, although the terms “first”, “second”, “third”, etc., may be used herein to describe various devices, elements, components, or sections, these devices, elements, components, or sections should not be limited by these terms. These terms are only used to distinguish one device, element, component, or section from another device, element, component, or section.

Although the present disclosure has been described in conjunction with some embodiments, it is not intended to be limited to the specific forms set forth herein. Rather, the scope of the present disclosure is limited only by the appended claims. Additionally, although individual features may be included in different claims, these may possibly be advantageously combined, and the inclusion in different claims does not imply that a combination of features is not feasible and/or advantageous. The order of features in the claims does not imply any specific order in which the features must be operated. Furthermore, in the claims, the word “comprising” does not exclude other elements, and the term “a” or “an” does not exclude a plurality. Reference signs in the claims are provided merely as a clarifying example and shall not be construed as limiting the scope of the claims in any way.

### INDUSTRIAL APPLICABILITY

In the embodiments of the present disclosure, the controller for a memory acquires the slot configuration information for defining the slot control mode, and the access requests to the target memory in the power-down mode of the target memory are cached using the command buffer. Then, the target memory is controlled according to the slot control mode to enter the low-power state in the power-down mode and process the access requests in the working mode, thereby achieving the control of the target memory based on slots. In this way, the controller may automatically cause the target memory to enter and exit the low-power state according to the slots, which can reduce the power consumption and save the resources without affecting the normal operation of the system and causing data loss.

1. A controller for a memory, comprising:
a slot control determination logic, configured to acquire slot configuration information for defining a slot control mode, the slot control mode indicating a switching mode between a working mode and a power-down mode in each control cycle of a target memory, wherein when only a slot unit in the slot configuration information is set to a fixed value, the slot control mode is a third control mode, and a command buffer has a first watermark, a first watermark timeout, a second watermark and a second watermark timeout, wherein the target memory is in the power-down mode when a number of access requests in the command buffer is less than the first watermark and a duration exceeds the first watermark timeout, and the target memory is in the working mode when the number of the access requests in the command buffer is greater than the second watermark and the duration exceeds the second watermark timeout, wherein the first watermark is less than the second watermark;
the command buffer, configured to cache the access requests to the target memory in the power-down mode of the target memory; and
a low-power control logic, configured to control the target memory according to the slot control mode, so that the target memory enters a low-power state in the power-down mode and processes the cached access requests to the target memory in the working mode.

2. The controller of claim 1, wherein when each of a number of power-down slots, a number of working slots, and the slot unit in the slot configuration information is set to a respective fixed value, the slot control mode is a first control mode.

3. (canceled)

4. The controller of claim 2, wherein the slot control determination logic is configured to:
in response to the number of the access requests in a unit time period being greater than a first threshold, a degree of variation between numbers of the access requests in neighboring unit time periods being less than a second threshold, and a bandwidth required for the access requests being smaller than a total bandwidth of the target memory, acquire slot configuration information for defining the first control mode.

5. The controller of claim 3, wherein the slot control determination logic is configured to:
in response to the number of the access requests in a unit time period being less than or equal to a first threshold, or a degree of variation between numbers of the access requests in neighboring unit time periods being greater than or equal to a second threshold, and a depth of the command buffer being greater than a third threshold, acquire slot configuration information for defining the second control mode.

6. The controller of claim 1, wherein the slot control determination logic is configured to:
in response to a degree of variation between numbers of the access requests in neighboring unit time periods being greater than or equal to a second threshold and a depth of the command buffer being less than or equal to the third threshold, acquire slot configuration information for defining the third control mode.

7. The controller of claim 2, wherein the number of the power-down slots, the number of the working slots, and the slot unit of the first control mode are configured to satisfy following conditions:
a product of the number of the power-down slots, the slot unit, a total bandwidth of the target memory, and a required bandwidth utilization rate is less than or equal to a product of a depth of the command buffer and a data length of each request;
a quotient obtained by dividing the number of the working slots by a sum of the number of the working slots and the number of the power-down slots is greater than or equal to the required bandwidth utilization rate; and
the number of the working slots is greater than or equal to a value of S/tREFI*tRFC; wherein S is the sum of the number of the working slots and the number of the power-down slots, tREFI is a refresh cycle of the target memory, and tRFC is a time required for refreshing all banks of the target memory.

8. The controller of claim 3, wherein the number of the power-down slots and the slot unit of the second control mode are configured to satisfy following condition:
a product of the number of the power-down slots, the slot unit, a total bandwidth of the target memory, and a required bandwidth utilization rate is less than or equal to a product of a depth of the command buffer and a data length of each request.

9. The controller of claim 2, wherein the target memory is a memory of one channel among memories of a plurality of channels, and the slot control mode comprises the first control mode;
the slot control determination logic is further configured to acquire the working mode of the target memory, wherein the working mode comprises one of a synchronous mode or a sequential mode, the synchronous mode indicates that the target memory and memories of other channels among the plurality of channels enter the working mode and the power-down mode synchronously, and the sequential mode indicates that the target memory and the memories of other channels among the plurality of channels enter the working mode and the power-down mode in a specified order; and
the low-power control logic is further configured to control the target memory according to the slot control mode and the working mode, so that the target memory enters the low-power state in the power-down mode and processes the cached access requests to the target memory in the working mode.

10. The controller of claim 1, wherein the slot control determination logic is further configured to control sending a refresh instruction to the target memory during a working slot to instruct the target memory to perform a refresh operation.

11. A chip system, comprising a target memory and a controller for the target memory, wherein the controller comprises:
a slot control determination logic, configured to acquire slot configuration information for defining a slot control mode, the slot control mode indicating a switching mode between a working mode and a power-down mode in each control cycle of the target memory, wherein when only a slot unit in the slot configuration information is set to a fixed value, the slot control mode is a third control mode, and a command buffer has a first watermark, a first watermark timeout, a second watermark and a second watermark timeout, wherein the target memory is in the power-down mode when a number of access requests in the command buffer is less than the first watermark and a duration exceeds the first watermark timeout, and the target memory is in the working mode when the number of the access requests in the command buffer is greater than the second watermark and the duration exceeds the second watermark timeout, wherein the first watermark is less than the second watermark;
the command buffer, configured to cache the access requests to the target memory in the power-down mode of the target memory; and
a low-power control logic, configured to control the target memory according to the slot control mode, so that the target memory enters a low-power state in the power-down mode and processes the cached access requests to the target memory in the working mode.

12. A control method for a memory, comprising:
acquiring slot configuration information for defining a slot control mode, the slot control mode indicating a switching mode between a working mode and a power-down mode in each control cycle of a target memory, wherein when only a slot unit in the slot configuration information is set to a fixed value, the slot control mode is a third control mode, and a command buffer has a first watermark, a first watermark timeout, a second watermark and a second watermark timeout, wherein the target memory is in the power-down mode when a number of access requests in the command buffer is less than the first watermark and a duration exceeds the first watermark timeout, and the target memory is in the working mode when the number of the access requests in the command buffer is greater than the second watermark and the duration exceeds the second watermark timeout, wherein the first watermark is less than the second watermark;
caching the access requests to the target memory in the power-down mode of the target memory using the command buffer; and
controlling the target memory according to the slot control mode, so that the target memory enters a low-power state in the power-down mode and processes the cached access requests to the target memory in the working mode.

13. The method of claim 12, wherein when each of a number of power-down slots, a number of working slots, and the slot unit in the slot configuration information is set to a respective fixed value, the slot control mode is a first control mode.

14. The method of claim 13, wherein the target memory is a memory of one channel among memories of a plurality of channels, and the slot control mode comprises the first control mode, wherein the method further comprises:
acquiring the working mode of the target memory, wherein the working mode comprises one of a synchronous mode or a sequential mode, the synchronous mode indicates that the target memory and memories of other channels among the plurality of channels enter the working mode and the power-down mode synchronously, and the sequential mode indicates that the target memory and the memories of other channels among the plurality of channels enter the working mode and the power-down mode in a specified order; and
wherein controlling the target memory according to the slot control mode comprises:
controlling the target memory according to the slot control mode and the working mode, so that the target memory enters the low-power state in the power-down mode and processes the cached access requests to the target memory in the working mode.

15. The controller of claim 1, wherein when only each of the number of the power-down slots and the slot unit in the slot configuration information is set to a respective fixed value, the slot control mode is a second control mode, and the number of the working slots is configured to be adaptive and dependent on the number of the access requests to the target memory that are cached by the command buffer in a control cycle.

16. The method of claim 12, wherein when only each of the number of the power-down slots and the slot unit in the slot configuration information is set to a respective fixed value, the slot control mode is a second control mode, and the number of the working slots is configured to be adaptive and dependent on the number of the access requests to the target memory that are cached by the command buffer in a control cycle.
